(19) United States
(12) Patent Application Publication
(10) Pub. No.: US 2008/0242231 A1
(43) Pub. Date: Oct. 2, 2008

(54) Updating Presence Based on Detecting User Activity

(75) Inventor: William Madison Gray, Fuquay-Varina, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/693,025

(22) Filed: Mar. 29, 2007

(51) Int. Cl. H04B 7/00

(52) U.S. Cl. 455/66.1

(57) ABSTRACT

A controller in a wireless communication device automatically generates and sends presence updates when a detector in the device senses user motion or other parameters related to the user's current activity. The presence updates may indicate that the user is performing the sensed activity. When the detector no longer senses the user motion or other parameters, the controller automatically generates and sends another presence update to indicate that the user is finished performing the activity.

### BACKGROUND

The present invention relates generally to wireless communications devices, and particularly to wireless communications devices that detect user activity.

Instant messaging allows users to send and receive text messages by establishing communications sessions. Historically, users have sent and received instant messages using a personal computer connected to the Internet. Given its popularity, however, it is no surprise that instant messaging has now moved to the realm of the wireless communications network. Users in both worlds can now send and receive text messages; however, the concept of “presence” has been modified slightly for mobile users.

“Presence” is a service that allows a user to inform other users about his reachability, availability, and willingness to communicate. The presence service indicates a user's presence status, for example, whether users are on-line, off-line, idle, busy, or on the phone. In addition, the presence service may provide information about a user's means and capabilities to send and receive some types of data such as video, audio, and text messages. A user who informs others of his or her presence status is referred to as a “presentity.” A user who wishes to be kept informed of another user's presence status is referred to as a “watcher.”

Typically, watchers who wish to be kept informed of a particular presentity's status subscribe to a presence server in a network. The subscription acts as a standing request to notify the watcher of any changes to the presentity's current presence status. When the presentity's status changes, the presentity notifies the presence server. The presence server than publishes the status change to the watcher.

Current presence services for mobile users indicate a person's ability to respond to received messages. The Open Mobile Alliance (OMA) Presence Enabler, for example, specifies a method of implementing presence for mobile users in which a user's status is determined by user preferences. For example, a user may be “ACTIVE” or “ONLINE” when the user is not engaged in a call, or “OFFLINE” when the user's device is powered down. Other statuses are also available, such as “BUSY” when the user is engaged in a call. Thus, a mobile user's status or ability to respond is implied by the activity of the mobile user.

However, the current presence paradigm does not accurately reflect all mobile user activities. Further, there is currently no way to determine some types of user activity and use that information to accurately update the mobile user's presence status.

### SUMMARY

In one embodiment, the present invention comprises a wireless communication device equipped with a sensor or detector that senses user motion or other parameter associated with a user's physical activity. For example, the sensor may be a pedometer that senses the user's steps when the user is running or walking, or a biometric sensor that senses the user's heartbeat or body temperature. The sensor generates output signals regarding the user motion or other parameter associated with a user's physical activity, and provides them to an activity monitor executed by a controller in the wireless communication device. Based on the output signals, the controller automatically generates and sends appropriate presence updates to a presence server located in a wireless communication network. The presence updates may include information describing the user's current activity, and thus, provide watchers with a more accurate description of the user's presence status.

The activity monitor may, in some embodiments, determine the user's current activity based on the output signals. For example, the sensor may generate an output signal each time the user takes a step. Based on the rate at which the activity monitor receives the output signals, it can determine whether the user is walking or running. The controller may then generate and send descriptive presence updates to the presence server.

Additionally, the controller may also determine a user's current geographic location. In one embodiment, for example, the wireless communication device includes a Global Positioning Satellite (GPS) receiver that receives location indications from orbiting satellites. In other embodiments, the wireless communication device receives location information from the network, or determines its current location with network assistance. The controller may use the current location information in conjunction with the output signals provided by the detector to generate and send presence updates that describe the user's activity at a specific location.

### BRIEF DESCRIPTION OF THE DRAWINGS

FIG. 1 is a block diagram illustrating a wireless communication device configured according to one embodiment of the present invention.

FIG. 2 is a perspective view of a wireless communication device configured according to one embodiment of the present invention.

FIG. 3 is a block diagram illustrating a communication network suitable for use with one embodiment of the present invention.

FIG. 4 is a flow diagram illustrating a method of performing one embodiment of the present invention.

FIG. 5 is a flow diagram illustrating a method of performing another embodiment of the present invention.

FIG. 6 is a flow diagram illustrating a method of performing another embodiment of the present invention.

FIG. 7 is a perspective view illustrating an alternate embodiment of the present invention.

### DETAILED DESCRIPTION

The present invention comprises a wireless communication device equipped with a detector or sensor that detects user motion or other parameter associated with a user's physical activity. For example, the detector may be a pedometer that senses the user's steps when the user is running or walking. The detector may also be a biometric sensor that senses the user's biometric information, such as a heartbeat, a pulse, or a body temperature. The detector provides output signals indicating the user's motion to an activity monitor executing on a controller in the wireless communication device. The activity monitor uses these output signals to determine a user's current activity. Based on that determination, the controller automatically generates and sends presence updates to a presence server. The presence updates reflect the user's current activity, and thus, provide watchers with a more accurate description of the user's actual presence status.

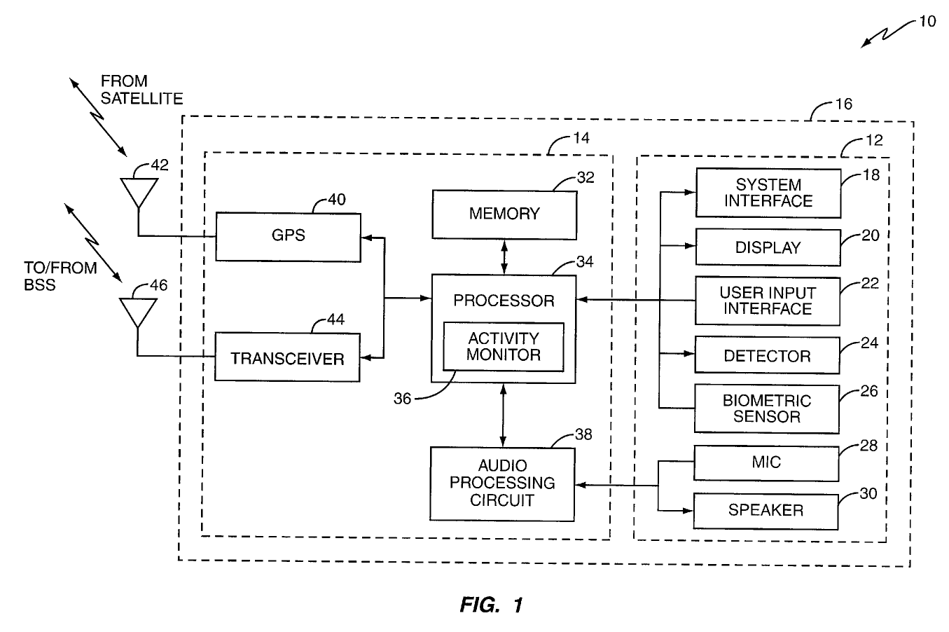

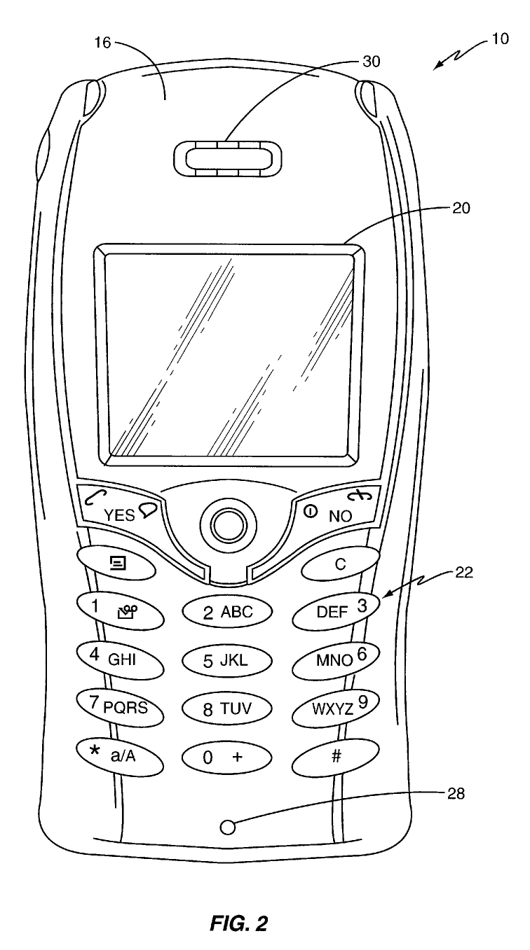

Turning now to the drawings, FIGS. 1 and 2 illustrate a wireless communication device 10 configured according to one embodiment of the present invention. As seen in the figures, wireless communication device 10 comprises a cellular radiotelephone; however, the present invention is not so limited. As used herein, the term “wireless communication device” may also include a Personal Communication System (PCS) terminal, a Personal Digital Assistant (PDA) having communication capabilities, or other appliance or mobile station that includes a radiotelephone transceiver capable of transmitting presence updates to a wireless communication network.

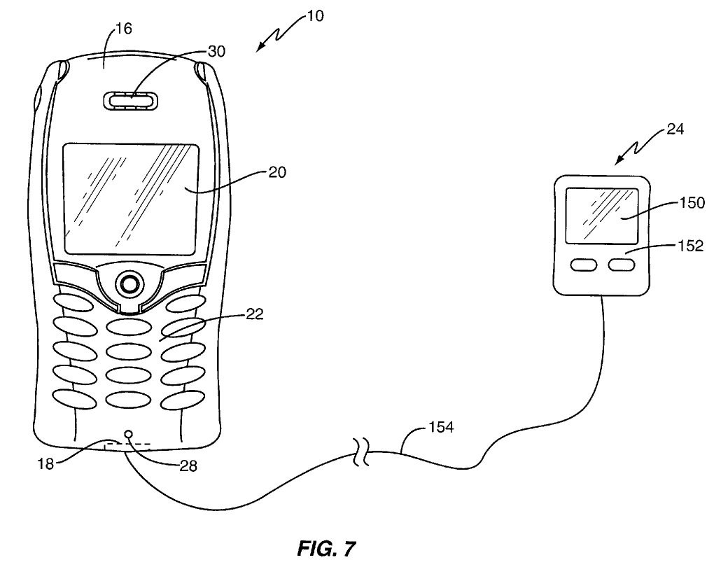

Wireless communication device 10 includes a user interface 12 and a communications circuit 14 in a housing 16. User interface 12 includes a system interface port 18, a display 20, a user input device 22, a motion detector 24, a biometric sensor 26, a microphone 28, and a speaker 30. User interface 12 generally permits the user to interact with and control wireless communication device 10. System interface port 18 may comprise a “male” or “female” connector that allows the user to connect wireless communications device 10 with any number of desired peripheral devices. Such devices include, but are not limited to, a hands-free headset (not shown), a battery charger (not shown), and, as described in more detail later, an external motion detector device (see FIG. 7). Display 20 allows a user to view information such as menus and menu items, dialed digits, images, call status information, output from user applications, and complementary multimedia effects, such as video clips and images downloaded as a reward to the user.

User input device 22 may include input devices such as a keypad, touchpad, joystick control dials, control buttons, and other input devices, or a combination thereof. The user input devices 22 allow the user to dial numbers, enter commands, scroll through menus and menu items presented to the user on display 20, and make selections. Microphone 28 receives and converts audible signals, such as the user's detected speech and other audible sound, into electrical audio signals that may be processed by audio processing circuit 38. Speaker 30 receives analog audio signals from audio processing circuit 38, and converts them into audible sound that the user can hear.

Detector 24 senses user motion associated with a user activity such as walking or running, for example. Detector 24 may be located internal to the wireless communications device 10 as seen in FIG. 1, or external to the wireless communications device 10 as seen in FIG. 7. Because detector 24 senses user motion, it may require initial and/or periodic calibration by the user. For detectors or sensors internal to wireless communications device 10, the user may control and/or calibrate detector 24 using user input device 22. As seen in FIG. 7, however, external detectors 24 may include their own display 150 and user interface 152 to allow the user to calibrate and/or control the operation of the external detector 24. Additionally, for external detectors or sensors, a cable 154 may connect the external detector 24 to wireless communications device 10 via system interface port 18.

In one embodiment, detector 24 comprises a pedometer. As is known in the art, pedometers are motion-sensitive devices having electrical circuits that turn on and off as the user walks or runs. Some pedometers, for example, use a magnetic pendulum that moves back and forth past a magnetic field with each step taken by the user. Other pedometers may detect the impact of the user's foot striking the ground. Regardless of how the pedometer detects the user's step, however, a digital circuit associated with the pedometer may be activated and deactivated to generate a pulse or signal that may be sent to controller 34.

Biometric sensor 26 comprises a device that is used to acquire biometric data about the user. By way of example, the sensor 26 may comprise a heart rate monitor that measures the user's heart rate or pulse, or a temperature gauge that measures the user's body temperature. Other types of biometric sensors, such as cameras and voice print mechanisms, are also possible. With each beat or pulse, the sensor 26 could generate an output signal to the controller 34. Based on these output signals, the controller 34 could determine whether the user is exercising.

The user may store his or her biometric signatures in memory 32 of device 10. Biometric signatures are data that may be used to indicate various levels of user activity. Techniques for generating biometric signatures are well known in the art and are not described in detail herein. The biometric sensor 26 outputs signals indicating the user's biometric functions to the controller 34, which then compares those signals to the biometric signatures stored in memory to infer or determine the type of user activity. For example, the controller 34 may compare the output signals to a biometric signature indicating a heart rate. Based on this comparison, the controller 34 may determine whether the user is running, walking, or standing relatively still.

Communication circuit 14 includes, inter alia, the components necessary to allow a user to communicate with one or more remote parties via a wireless communications link. Communication circuit 14 comprises memory 32, a controller 34, an activity monitor 36, an audio processing circuit 38, a transceiver 40 coupled to an antenna 42, and a GPS receiver 44 coupled to an antenna 46. Memory 32 represents the entire hierarchy of memory in wireless communications device 10, and may include both random access memory (RAM) and read-only memory (ROM), as well as magnetic or optical disk storage. Computer program instructions and data required for operation are stored in non-volatile memory, such as EPROM, EEPROM, and/or flash memory, and may be implemented as discrete devices, stacked devices, or integrated with controller 34.

Controller 34 controls the operation of wireless communications device 10 according to programs and/or data stored in memory 32. The control functions may be implemented in a single microprocessor, or in multiple microprocessors. Suitable processors may include, for example, both general purpose and special purpose microprocessors. Controller 34 may interface with audio processing circuit 38, which provides basic analog output signals to speaker 30 and receives analog audio inputs from microphone 28.

In addition, controller 34 may execute an activity monitor 36. The activity monitor comprises logic that receives and processes the output signals generated by detector 24. For example, the activity monitor 36 may receive the output signals at various rates. The activity monitor 36 could then compare the rates to biometric signatures or other parameters associated with the user's physical activity stored in memory, and interpret the results of the comparison to determine if the user is moving or exercising. Based on that determination, presence logic executing on controller 34 may automatically generate a presence update message, and control wireless communications device 10 transmit the presence update message via transceiver 40 to a presence server via Base Station Subsystem (BSS) in a wireless communication network.

Transceiver 44 and antenna 46 allow a user to wirelessly communicate speech and data signals to and from a BSS in a wireless communications network. Transceiver 44 may be a fully functional cellular radio transceiver that operates according to any known standard, including the standards known generally as the Global System for Mobile Communications (GSM), TIA/EIA-136, cdmaOne, cdma2000, UMTS, and Wideband CDMA. In addition, transceiver 44 may include baseband-processing circuits to process the transmitted and received signals. Alternatively, however, baseband-processing circuits may be incorporated in controller 34.

GPS receiver 40 and antenna 42 allow a user to receive information indicative of the current geographical location of the device 10. As is known in the art, the GPS receiver 40 receives location data from one or more satellites (not shown). In one embodiment, the controller 34 processes the received GPS signals to determine where the user is located geographically. In other embodiments, the GPS receiver 40 includes its own processor to determine the user's geographic location. Once determined, the GPS receiver 42 may provide controller 34 with coordinates or other data representative of the user's geographic location.

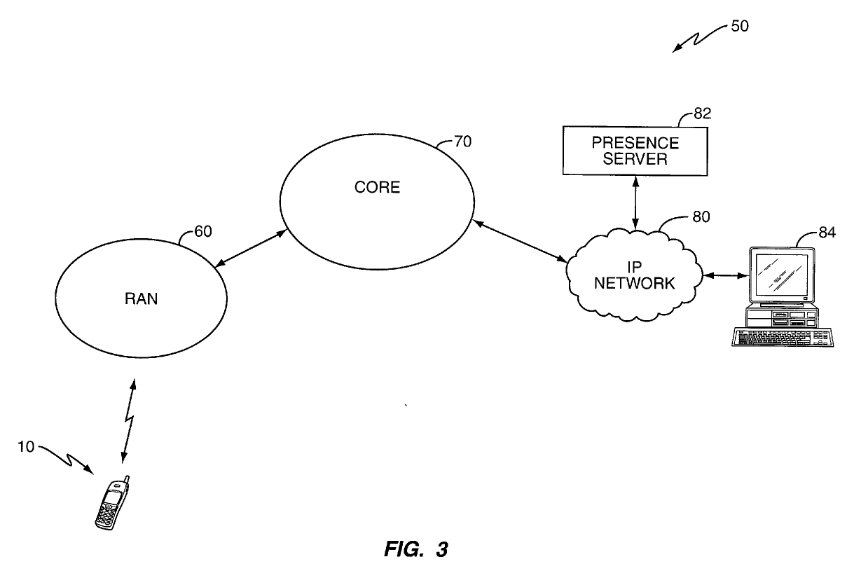

As stated above, the wireless communication device 10 is capable of sending presence updates to a remote presence server. FIG. 3 illustrates some of the main functional elements of a wireless communications network 50 suitable for use with the present invention. The wireless communications network 50 may, for example, comprise a GSM/GPRS network, cdma2000 network, or Wideband CDMA network. The wireless communications network 50 comprises a radio access network (RAN) 60, a core network (CN) 70, and an IP network 80. The RAN 60 supports radio communications with wireless communication device 10 over an air interface as is known in the art. The wireless communications network 50 typically includes more than one RAN 60 though only one is shown in FIG. 3.

The CN 70 provides a connection to an IP network 80, such as the Internet or other packet data network (PDN) for packet switched services. In some networks, CN 70 may also provide a connection to the Public Switched Telephone Network (not shown) and/or the Integrated Digital Services Network (not shown) for circuit-switched services, such as voice and fax services. The CN 70 may include an access gateway (not shown) for interconnecting with the IP network 80. The access gateway may be, for example, a GPRS Gateway Serving Node (GGSN) for GPRS networks, or a Packet Data Serving Node (PDSN) for cdma2000 networks.

Presence server 82 connects to the CN 70 via IP network 80. However, in some embodiments, the presence server 82 may be resident within or connect directly to CN 70. The wireless communication device 10 transmits presence updates to presence server 82 whenever the presence status of the user changes. The presence server 82 may then disseminate these status changes to one or more watchers as presence notifications. Device 10 may use an access independent session control protocol (SCP), such as the Session Initiation Protocol (SIP) to support presence notification. SIP is an application layer control protocol for establishing, modifying, and terminating communication sessions between one or more participants. These sessions may include, for example, Internet multimedia conferences, Internet telephony calls, multimedia distributions, and network gaming. In some networks, SIP has also been extended to support presence services. The SIP is well known in the art, and is described in the Internet Engineering Task force (IETF) document RFC 3261, which is incorporated herein by reference in its entirety.

As previously stated, a mobile user's presence status or ability to respond to messages is implied by the user's current activity. However, presence status as currently defined might not accurately reflect a mobile user's presence under some circumstances. For example, some mobile users like to walk or jog for exercise. These users may carry their cellular telephones with them to listen to music stored thereon, or to be able to place/receive emergency phone calls should the need arise. Typically, however, users do not wish to send or receive text messages while exercising. Under the current presence model, watchers might see an exercising user's status as “ACTIVE” “ONLINE,” or even “BUSY,” because the cellular telephones are powered on. However, these labels do not accurately reflect the user's actual activity or desire to respond to communications.

Therefore, the present invention employs detector 24 to sense motion or other parameters related to the user's current activity, such as when the user is running or jogging, and uses that information to automatically update the user's presence status. Particularly, the controller 34 automatically generates presence updates and sends the presence updates to the presence server 82 when the detector 24 senses that the user is walking or running. When the detector 24 no longer senses motion associated with this activity, the controller 34 automatically generates and sends another presence update to indicate that the user has finished the activity. Such sensor-based presence update generation more accurately reflects the user's current activity and desire to communicate with remote parties without the need for the user to perform manual functions.

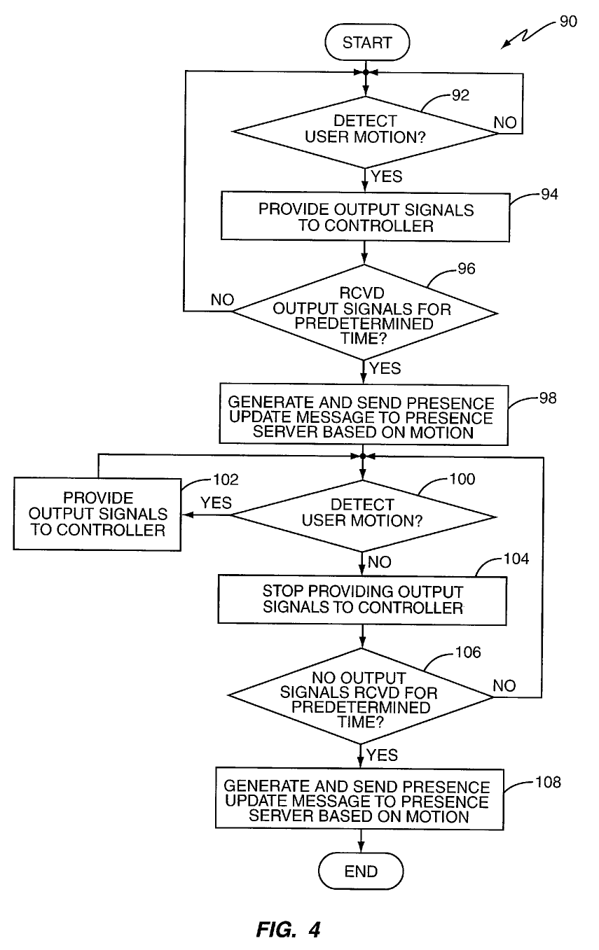

FIG. 4 is a flow diagram illustrating a method 90 of generating and sending appropriate presence updates according to one embodiment of the present invention. In this embodiment, detector 24 comprises a pedometer that senses the user's steps as the user walks, jogs, or runs, for example (box 92). Responsive to sensing the user motion, the detector 24 generates and provides output signals to the controller 34 (box 94). For example, detector 24 may provide the activity monitor 36 with an output signal each time the user takes a step. So long as the activity monitor 36 continues to receive the output signals for a predetermined time (e.g., 30 seconds) (box 96), the activity monitor 36 assumes that the user is jogging or running as opposed to walking a short distance. Based on this information, the controller 34 may generate a presence update to show that the user is “RUNNING,” or “JOGGING,” and send that presence update to presence server 82 (box 98). Should activity monitor 36 stop receiving the output signals for a predetermined time, activity monitor 36 may assume that the user is simply walking or moving a short distance. In these cases, the controller 34 may refrain from generating a presence update, and the detector 24 would continue to sense user motion (box 100).

After the presence update is sent, the detector 24 continues to sense the user motion (box 100) and provide control signals to the activity monitor 36 so long as the user maintains movement (box 102). Once the detector 24 stops sensing the user motion, it ceases generating and providing the activity monitor 36 with the control signals (box 104). Should the activity monitor 36 not receive control signals for a predetermined period of time (box 106), it assumes that the user is finished running or jogging. Controller 34 could then generate and send a presence update to the presence server 82 indicating that the user is again “ACTIVE,” or “ONLINE” (box 108). Otherwise, the controller 34 would assume that the user is not finished and continue to receive control signals from detector 24.

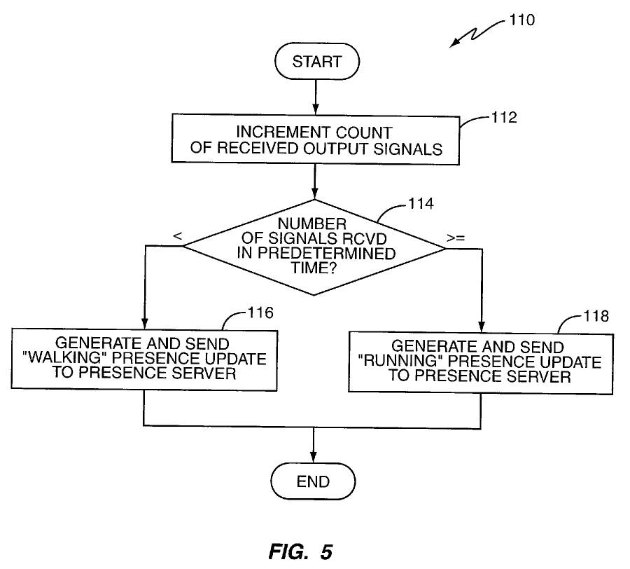

In the embodiment of FIG. 4, the output signals comprise pulses generated by the detector 24 each time the user takes a step. The activity monitor 36 could use this information to determine the extent or type of user activity, and use that information in the generated presence update to provide a more accurate description of that activity. FIG. 5, for example, illustrates a method 110 in which the activity monitor 36 distinguishes whether the user is walking or running by counting the number of control signals received within a predetermined time (e.g., 10 seconds). Particularly, the activity monitor 36 could increment a counter each time it receives an output signal from the detector 24 indicating that the user has taken a step (box 112). If the counter reflects that the number of steps within a predetermined time is less than some predetermined threshold (box 114), the controller 34 could generate and send a presence update to the presence server indicating that the user is walking (box 116). If the number of steps within the predetermined time is equal to or exceeds the threshold, the controller 34 could generate and send a presence update indicating that the user is running (box 118).

Similarly, biometric sensor 26 may provide the activity monitor 36 with data indicating the user's biometric functions. By way of example, each output signal generated by the biometric sensor 26 could represent a beat of the user's heart or the user's body temperature. The activity monitor 26 could count the beats or monitor the temperature, and compare that information to the biometric signatures stored in memory 32 to determine the user's activity. A user who is running, for example, might have a higher heart rate or body temperature than when the user is walking. Therefore, rates and/or temperatures above a predetermined threshold could be considered as running, while other rates and/or temperatures lower than the threshold could be considered walking.

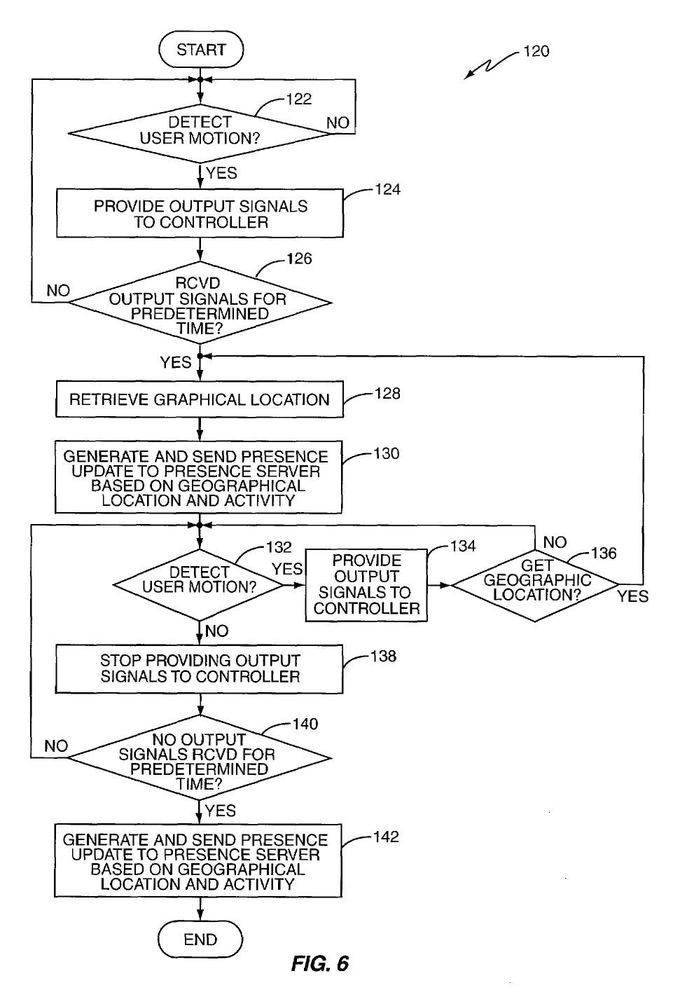

In addition to the information provided by the detector 24, the controller 34 might also use other information gathered by device 10 in generating a presence update. FIG. 6, for example, illustrates one method 120 wherein the user's device 10 generates and sends a presence update to the presence server 82 based on both the current activity of the user as indicated by the detector 24 and the current location of the user.

Method 120 begins when detector 24 senses the user's steps and provides control signals indicating those steps to the activity monitor 36 (boxes 122, 124). As previously described, the activity monitor 36 may determine whether the user is actually walking or running for exercise, or simply moving between locations based on a rate at which the detector 24 is generating the output signals (box 126). If activity monitor 36 determines that the user is walking or running for exercise, for example, the controller 34 may then determine the user's current location (box 128). The geographical location may be obtained by any method known in the art. One embodiment, for example, utilizes the geographical information provided by the GPS receiver 40. However, other embodiments use geographical location information provided by the network. Once the controller 34 obtains the user's current location, the controller 34 automatically generates the presence update to reflect the user's current activity and the user's current geographical location, and sends that presence update to the presence server 82 (box 130).

By way of example, the presence update may indicate that the user is “WALKING” or “RUNNING” at a location near his house. The location may reflect geographical coordinates, or may reflect an intersection, a street, or building. To obtain these descriptions, the user may store the coordinates of certain locations in a table in memory and associate those locations with labels. Controller 34 could use the coordinates provided by the GPS receiver 40 as an index into that table, for example, and retrieve the associated label for use in generating the presence update.

Throughout the user's exercise session, the geographical location may be periodically updated. So long as the detector 24 senses the user's motion, the present invention may be configured to update the user's current location (boxes 132, 134, 136), and use that updated location information in generating the presence updates (boxes 128, 130). This permits watchers to follow the user's progress in cases where the user typically walks or runs along the same route. In other cases, such as when the user walks or runs on a treadmill at a fixed location such as at home or a gym, for example, the geographical location could let the watchers know that the user is exercising at that location.

The detector 24 ceases to provide the output signals when it senses that the user has stopped moving (boxes 132). If the activity monitor 36 does not receive the output signals for a predetermined period of time (box 140), the activity monitor 36 can assume that the user has stopped exercising. The controller 34 then generates and sends another presence update to indicate that the user has stopped walking or running (box 142). Otherwise, the activity monitor 36 assumes that the user is continuing to exercise, and continues to receive the output signals generated by detector 24 (box 132).

FIG. 7 illustrates an embodiment where an external detector 24 connects to device 10 via a cable 154 and system interface 18. Such external detectors 24 may include their own display 150 and controls 152 so that the user can calibrate the external detector 24 when needed or desired. The external detector 24 would generate and provide the output signals to the activity monitor 36 via cable 154 and system interface 18.

While a preferred embodiment of the invention as described herein uses a pedometer as a detector 24, those skilled in the art will appreciate that the present invention is not so limited. The detector 24 may comprise an accelerometer, for example, or some other sensor that detects user movement and/or biometric functions.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless communication device comprising:
a detector configured to generate output signals responsive to a user activity;
an activity monitor configured to determine the user activity based on the output signals;
a controller configured to generate presence updates based on the determination by the activity monitor; and
a transmitter configured to transmit the presence updates.

2. The device of claim 1 wherein the controller is configured to generate the presence updates if the detector generates the output signals for a predetermined period of time.

3. The device of claim 2 wherein the controller is configured to stop generating the presence updates if the detector does not generate the output signals for a predetermined period of time.

4. The device of claim 1 wherein the detector comprises a biometric sensor, and wherein the output signals comprises biometric data captured by the biometric sensor that indicate that the user is exercising.

5. The device of claim 1 wherein the detector comprises a pedometer, and wherein the output signals comprise indications that the user is exercising.

6. The device of claim 1 further comprising a location determining device configured to determine a current location of the wireless communication device.

7. The device of claim 6 wherein the controller is further configured to generate the presence updates based on the current location of the wireless communication device.

8. The device of claim 1 wherein the activity monitor is further configured to determine a type of user motion based on the output signals.

9. The device of claim 1 wherein the activity monitor comprises application logic that receives the output signals from the detector.

10. The device of claim 9 wherein the activity monitor is configured to determine whether the user is exercising based on the output signals.

11. A method of updating presence from a wireless communication device, the method comprising:
generating output signals responsive to sensing one or more parameters related to a user's current activity;
generating presence updates based on the output signals; and
transmitting the presence updates to indicate the user's current activity.

12. The method of claim 11 wherein generating presence updates based on the output signals comprises generating the presence updates if the output signals are generated for a predetermined time.

13. The method of claim 12 further comprising ceasing to generate the presence updates if the output signals are not generated for a predetermined time.

14. The method of claim 11 wherein the output signals comprise biometric data output by a biometric sensor.

15. The method of claim 11 wherein the output signals comprise signals output by a pedometer.

16. The method of claim 11 further comprising determining a current location of the wireless communication device.

17. The method of claim 16 further comprising generating the presence updates based on the output signals and on the current location of the wireless communication device.

18. The method of claim 11 further comprising determining the user's current activity based on the output signals.

19. The method of claim 11 further comprising determining that the user is exercising based on the output signals.
